(19) United States
(12) Patent Application Publication
(10) Pub. No.: US 2010/0253581 A1
(43) Pub. Date: Oct. 7, 2010

(54) MULTIBAND ANTENNA AND PORTABLE WIRELESS COMMUNICATION DEVICE USING THE SAME

(75) Inventor: TUN-YUAN TSOU, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/485,127

(22) Filed: Jun. 16, 2009

(30) Foreign Application Priority Data
Apr. 3, 2009 (CN) 200910301353.4

(51) Int. Cl. H01Q 1/38; H01Q 1/24

(52) U.S. Cl. 343/702; 343/700 MS

(57) ABSTRACT

A multiband antenna includes a feed end, a grounding end, a first radiating arm, a connecting portion, a second radiating arm and a third radiating arm. The feed end and the grounding end are connected to the first radiating arm to form an F-shaped antenna, and obtain a first resonance frequency. The second radiating arm generates a coupling effect with the first radiating arm, and obtains a second resonance frequency. The third radiating arm generates a coupling effect with the second radiating arm, and obtains a third resonance frequency.

### BACKGROUND

1. Technical Field

The disclosure generally relates to antennas, particularly to a multiband antenna and a portable wireless communication device using the multiband antenna.

2. Description of Related Art

With the developments of wireless communication and information processing technologies, portable wireless communication devices such as mobile phones and personal digital assistants (PDAs) are now in widespread use, and consumers may now enjoy the full convenience of high tech products almost anytime and anywhere.

Typical portable wireless communication devices generally include a single band antenna assembled therein to transmit and receive electromagnetic waves. The single band antenna only allows transmission and receiving of only one frequency band for communication and does not provide the flexibility of using multiple frequency bands suitable for different communication systems such as Bluetooth, WiMAX, and WLAN. The working frequency bands of the Bluetooth, WiMAX, and WLAN communication systems are 2.4˜2.48 GHz, 3.4˜3.7 GHz, and 5.15˜5.35 GHz. Theoretically, using different antenna for each frequency band can solve the aforesaid problems. However, multiple antennas will inevitably increase the cost of manufacturing portable wireless communication devices, and occupy a large space within portable wireless communication devices.

Therefore, there is room for improvement within the art.

### BRIEF DESCRIPTION OF THE DRAWINGS

Many aspects of the multiband antenna and the portable wireless communication device can be better understood with reference to the following drawings. The components in the drawings are not necessarily drawn to scale, the emphasis instead being placed upon clearly illustrating the principles of the multiband antenna and the portable wireless communication device.

FIG. 1 shows a front elevational view of a multiband antenna mounted on a base board of a portable wireless communication device, according to the first exemplary embodiment.

FIG. 2 shows exemplary dimensions of an exemplary embodiment of the multiband antenna of FIG. 1.

FIG. 3 shows an exemplary test graph obtained from the multiband antenna of FIG. 1, disclosing return loss varying with frequency.

FIG. 4 shows a front elevational view of a multiband antenna mounted on a base board of a portable wireless communication device, according to the second exemplary embodiment.

FIG. 5 shows an exemplary test graph obtained from the multiband antenna of FIG. 4, disclosing return loss varying with frequency.

### DETAILED DESCRIPTION

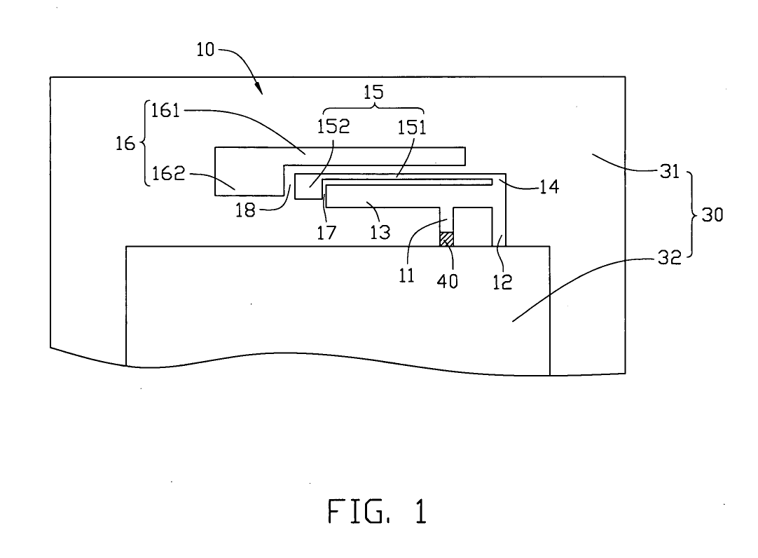

FIG. 1 shows a multiband antenna 10 according to the first exemplary embodiment. In use, the multiband antenna 10 is installed on a base board 30 of a portable electronic device (not shown), such as a mobile phone and a personal digital assistant (PDA), to receive and/or send wireless signals. In the first exemplary embodiment, the multiband antenna 10 is formed on the base board 30 with copper material using sculpture printing.

The base board 30 is a printed circuit board including a mounting portion 31 and a grounding portion 32. The mounting portion 31 is configured for mounting on the multiband antenna 10. The grounding portion 32 is for providing a grounding plane for the multiband antenna 10.

The multiband antenna 10 includes a feed end 11, a grounding end 12, a first radiating arm 13, a connecting portion 14, a second radiating arm 15 and a third radiating arm 16. The feed end 11 and the grounding end 12 are connected to the first radiating arm 13 to form an F-shaped antenna, and obtain a first resonance frequency. The second radiating arm 15 generates a coupling effect with the first radiating arm 13, and obtains a second resonance frequency. The third radiating arm 16 generates a coupling effect with the second radiating arm 15, and obtains a third resonance frequency. In this exemplary embodiment, the first resonance frequency, the second resonance frequency and the third resonance frequency are 2.4 GHz, 3.5 GHz and 5.2 GHz, and suitable for working with Bluetooth, WiMAX, and WLAN communication systems.

The feed end 11 and the grounding end 12 are both sheet-shape. The width of the feed end 11 is approximately equal to that of the grounding end 12. The length of the feed end 11 is slightly shorter than that of the grounding end 12. One end of the feed end 11 is perpendicularly connected to one side of the first radiating arm 13, and another end of the feed end 11 is perpendicularly connected to a signal feed portion (not shown) of the wireless communication device via a feed device 40. One end of the grounding end 12 is perpendicularly connected to the first radiating arm 13, and another end of the grounding end 12 is perpendicularly connected to the grounding portion 32. Thus the grounding end 12 is parallel to the feed end 11. The first radiating arm 13 is parallel to the grounding portion 32. The first radiating arm 13 is perpendicularly connected to the feed end 11 and the grounding end 12 at the side adjacent to the grounding portion 32 to form an F-shaped antenna, and obtains a first resonance frequency of 2.4 GHz.

The connecting end 14 is formed by perpendicularly extending from the side of the first radiating arm 13 opposite to the grounding end 12. One end of the connecting end 14 is connected to the second radiating arm 15.

The second radiating arm 15 is an approximately L-shaped sheet including a first arm portion 151 and a first bent portion 152 perpendicularly connected to the first arm portion 151. The second radiating arm 15 is positioned on the side of the first radiating arm 13 opposite to the grounding portion 32. The first arm portion 151 is parallel to the first radiating arm 13. One end of the first arm portion 151 opposite to the first bent portion 152 is perpendicularly connected to the connecting end 14. The length of the first arm portion 151 is slightly longer than that of the first radiating arm 13. A first L-shaped slot 17 is formed between the second radiating arm 15 and the first radiating arm 13. A second resonance frequency of 3.5 GHz is obtained via the coupling effect generating by the second radiating arm 15 and the first radiating arm 13. In addition, the second resonance frequency can be adjusted by changing a width of the first slot 17.

The shape of the third radiating arm 16 is substantially the same as the second radiating arm 15. The third radiating arm 16 is an L-shaped sheet including a second arm portion 161 and a second bent portion 162 perpendicularly connected to the second arm portion 161. The third radiating arm 16 is set at the side of the second radiating arm 15 opposite to the first radiating arm 13. The second arm portion 161 is parallel to the first arm portion 151. The second bent 162 is parallel to the first bent portion 152. Thus a second L-shaped slot 18 is formed between the third radiating arm 16 and the second radiating arm 15, and obtains a third resonance frequency of 5.2 GHz via the coupling effect generating by the second radiating arm 15 and the third radiating arm 16. The third resonance frequency can be adjusted by changing a width of the second slot 18.

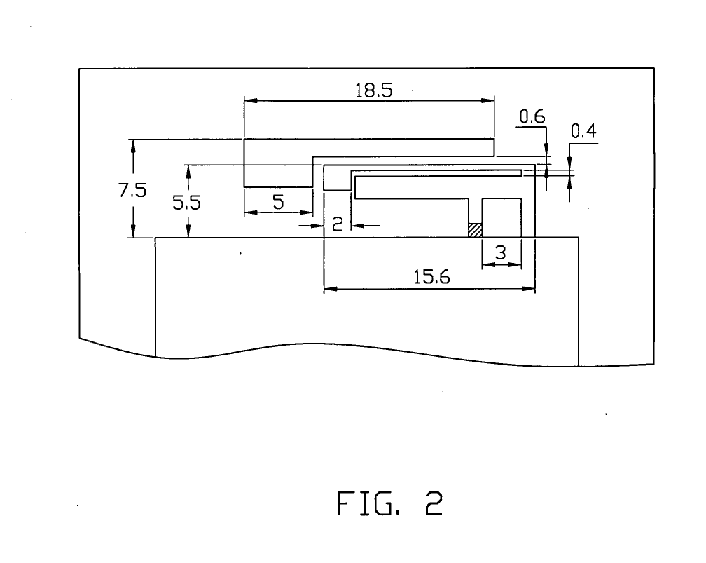

Referring to FIG. 2, in an exemplary embodiment, the width between the feed end 11 and the grounding end 12 is 3mm. The length of the first arm portion 151 is 15.6 mm. The width between the first radiating arm 13 and the second radiating arm 15 is 0.4 mm. The distance from the periphery edge of first arm portion 151 to the grounding portion 32 is 5.5 mm. In addition, the width of first extending portion 152 is 2 mm. The length of the second arm portion 161 is 18.5 mm. The width between the second radiating arm 15 and the second arm portion 161 is 0.6 mm. The distance from the peripheral edge of the second arm portion 161 to the grounding portion 32 is 7.5 mm. The width of the second bent portion 162 is 5 mm. These dimensions are merely exemplary and do not limit the scope of the invention.

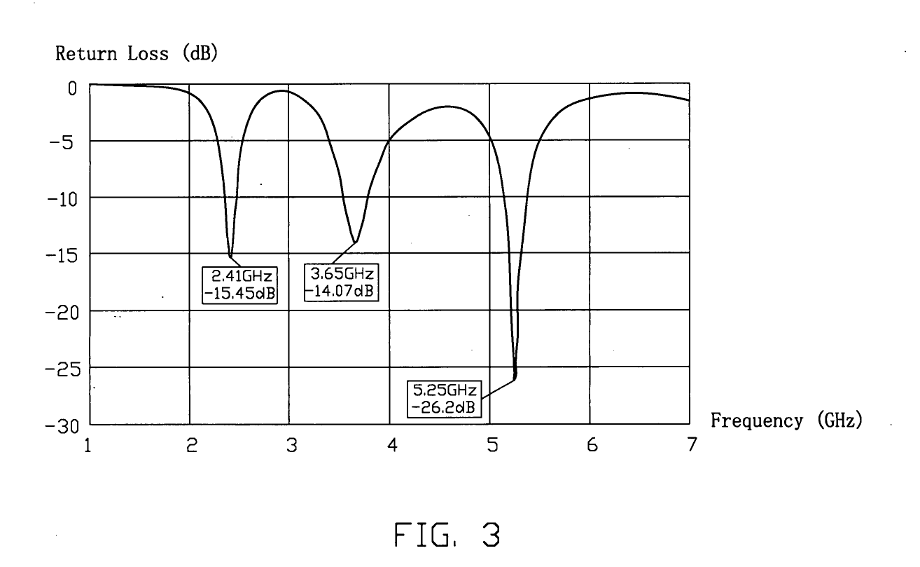

Referring to FIG. 3, during the test, the multiband antenna generates three resonance frequencies of 2.4 GHz, 3.5 GHz and 5.2 GHz, suitable for working with Bluetooth, WiMAX, and WLAN communication systems.

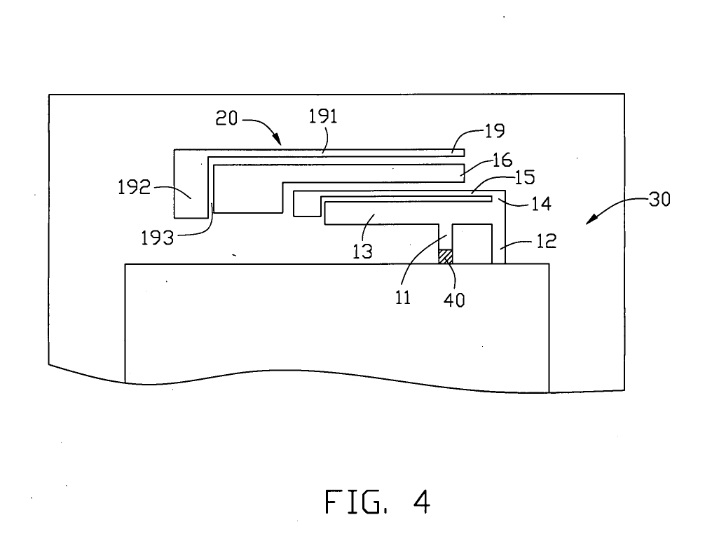

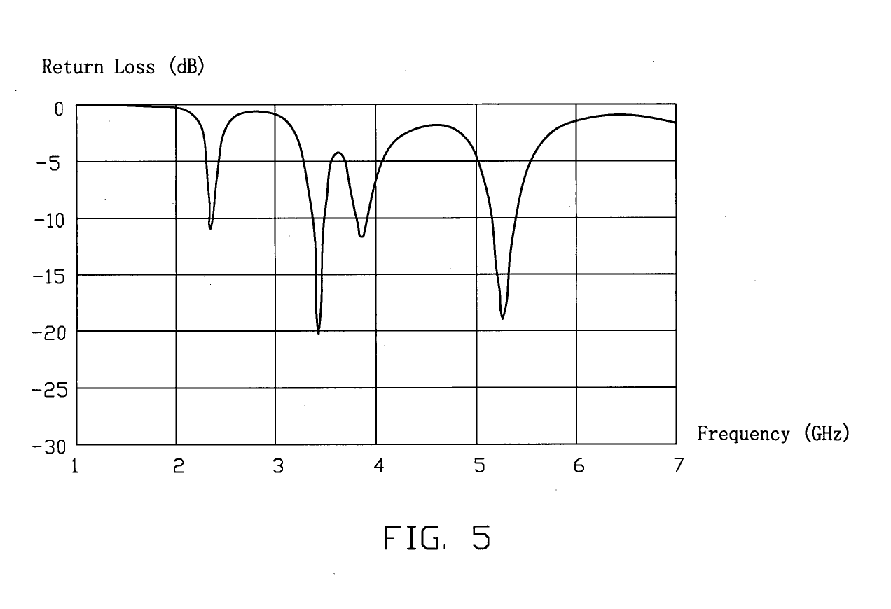

FIG. 4 shows a multiband antenna 20 according to a second exemplary embodiment. The multiband antenna 20 is similar to the multiband antenna 10 and further includes a fourth radiating arm 19 to obtain a fourth radiating resonance frequency. The fourth radiating arm 19 is an L-shaped sheet including a third arm portion 191 and a third bent portion 192 perpendicularly connected to the third arm portion 191. The third arm portion 191 is parallel to the second arm portion 161. A third slot 193 is formed between the fourth radiating arm 19 and the third radiating arm 16. According to FIG. 5, during the test, the multiband antenna 20 generates four resonance frequencies for communication.

The structure of the multiband antenna is planar, and does not occupy much space within portable wireless communication devices, which is advantageous to miniaturization of mobile phones. Further more, the multiband antenna provides multiple frequency bands suitable for different communication systems, which reduce the cost of portable wireless communication device working for multiple communication systems.

It is believed that the exemplary embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A multiband antenna used in a portable wireless communication device, comprising:
a feed end;
a grounding end;
a first radiating arm, the feed end, the grounding end and the first radiating arm forming an F-shaped antenna, and obtaining a first resonance frequency;
a connecting end;
a second radiating arm; and
a third radiating arm, wherein the second radiating arm is connected to the connecting end, and forms a first slot with the first radiating arm, and obtains a second resonance frequency; the third radiating arm is set at one side of the second radiating arm, and forms a second slot with the second radiating arm, and obtains a third resonance frequency.

2. The multiband antenna as claimed in claim 1, wherein the second radiating arm is an L-shaped sheet, and the first slot formed by the second radiating arm and the first radiating arm is L-shaped.

3. The multiband antenna as claimed in claim 2, wherein the second radiating arm includes a first arm portion and a first bent portion perpendicularly connected to the first arm portion, the first arm portion is parallel to the first radiating arm, one end of the first arm portion apposite to the first bent portion is perpendicularly connected to the connecting end.

4. The multiband antenna as claimed in claim 3, wherein the third radiating arm is an L-shaped sheet, and the second slot formed by the third radiating arm and the second radiating arm is L-shaped.

5. The multiband antenna as claimed in claim 4, wherein the third radiating arm includes a second arm portion and a second bent portion perpendicularly connected to the second arm portion, the second arm portion is parallel to the first arm portion, the second bent portion is parallel to the first bent portion.

6. The multiband antenna as claimed in claim 1, wherein the multiband antenna further includes a fourth radiating arm set on the side of the third radiating arm opposite to the second radiating arm.

7. The multiband antenna as claimed in claim 6, wherein the fourth radiating arm is an L-shaped sheet including a third arm portion and a third bent portion perpendicularly connected to the third arm portion.

8. A portable wireless communication device comprising:
a base board; the base board includes a mounting portion and a grounding portion for offering a grounding plane and
a multiband antenna; the mounting portion being for mounting the multiband antenna; the multiband antenna comprising:
a feed end;
a grounding end;
a first radiating arm, the feed end, the grounding end and the first radiating arm forming an F-shaped antenna, and obtaining a first resonance frequency;
a connecting end;
a second radiating arm; and
a third radiating arm, wherein the second radiating arm is connected to the connecting end, and forms a first slot with the first radiating arm, and obtains a second resonance frequency; the third radiating arm is set at one side of the second radiating arm, and forms a second slot with the second radiating arm, and obtains a third resonance frequency.

9. The portable wireless communication device as claimed in claim 8, wherein the second radiating arm is an L-shaped sheet, and the first slot formed by the second radiating arm and the first radiating arm is L-shaped.

10. The portable wireless communication device as claimed in claim 9, wherein the second radiating arm includes a first arm portion and a first bent portion perpendicularly connected to the first arm portion, the first arm portion is parallel to the first radiating arm, one end of the first arm portion apposite to the first bent portion is perpendicularly connected to the connecting end.

11. The portable wireless communication device as claimed in claim 10, wherein the third radiating arm is an L-shaped sheet, and the second slot formed by the third radiating arm and the second radiating arm is L-shaped.

12. The portable wireless communication device as claimed in claim 11, wherein the third radiating arm includes a second arm portion and a second bent portion perpendicularly connected to the second arm portion, the second arm portion is parallel to the first arm portion, the second bent portion is parallel to the first bent portion.

13. The portable wireless communication device as claimed in claim 8, wherein the multiband antenna further includes a fourth radiating arm set on the side of the third radiating arm opposite to the second radiating arm.

14. The portable wireless communication device as claimed in claim 13, wherein fourth radiating arm is an L-shaped sheet including a third arm portion and a third bent portion perpendicularly connected to the third arm portion.
